(19) United States
(12) Patent Application Publication
(10) Pub. No.: US 2003/0033790 A1
(43) Pub. Date: Feb. 20, 2003

(54) Bed air purification system

(76) Inventor: Stephen Hague, Cohasset, MA (US)

Correspondence Address: Iandiorio & Teska, 260 Bear Hill Road, Waltham, MA, 02451-1018, US

(21) Appl. No.: 09/929,641

(22) Filed: Aug. 14, 2001

(51) Int. Cl. B01D 46/00

(52) U.S. Cl. 55/385.1

(57) ABSTRACT

A bed air purification system including a mattress; a headboard at the head of the mattress with an air chamber therein and including a number of openings in communication with the air chamber; an air filtration device; and a duct interconnecting the air filtration device and the air chamber of the headboard to thereby provide a blanket of filtered air over the face of a person lying on the mattress.

### FIELD OF THE INVENTION

This invention relates to an air purification system wherein a blanket of filtered air is blown at a low velocity from a headboard over the face of a person lying on the bed.

### BACKGROUND OF THE INVENTION

People suffering from severe allergies or asthma typically purchase and use air filtration devices to filter out pollutants, animal dander, pollen, and the like in a room.

The primary problem associated with these devices is that although they are effective at filtering the air, the filtered air quickly mixes with non-filtered air before being breathed in by the allergy or asthma sufferer.

Current air filter devices are too noisy and/or eject filtered air at too high a rate to be placed in close proximity to a person sleeping on a bed. Thus, when the person sleeps, the filtered air quickly mixes with non-filtered bedroom air since the air filtration device is usually located some distance from the person's bed.

### SUMMARY OF THE INVENTION

It is therefore an object of this invention to provide an air purification system which provides a blanket of filtered air directly over the face of a person lying on a bed.

It is a further object of this invention to provide such a system which offers relief for people suffering from allergies or asthma.

It is a further object of this invention to provide such a system which can be integral with and designed to include the headboard of the bed itself.

It is a further object of this invention to provide such a system which can be retrofitted and used with existing bed headboards.

The invention results from the realization that non-filtered air can be prevented from being mixed with filtered air before it is breathed in by a person by a uniquely designed bed headboard having a set of openings distributed across the width thereof, an air filtration device, and a duct interconnecting the air filtration device with an air chamber inside the headboard to thereby provide a low velocity blanket of filtered air directly over the face of a person lying on a the mattress of a bed.

This invention features a bed air purification system comprising a mattress; a headboard at the head of the mattress with an air chamber therein and including a number of openings in communication with the air chamber; an air filtration device; and a duct interconnecting the air filtration device and the air chamber of the headboard to thereby provide a blanket of filtered air over the face of a person lying on the mattress.

Typically, the openings are vertically running slits. In the preferred embodiment, the headboard has an upper portion above the mattress and a lower portion below the mattress and the openings disposed in the upper portion of the headboard. The headboard includes front and back panels, two sidewalls, and a top and a bottom defining the air chamber therebetween. The front panel includes an upper portion above the mattress and a lower portion below the mattress, the upper portion of the front panel made of spaced vertically running slats, the openings being the spacing between the spaced slats. In one embodiment, a screen is disposed behind the slats.

A typical the air filtration device includes an air intake, an air outtake connected to the duct, a HEPA filter and a fan which draws air in through the air intake, through the HEPA filter, and out the outtake. The air filtration device may be located under the mattress, at the foot of the mattress, or beside the mattress. Preferably the openings are evenly distributed across the entire width of the headboard.

The bed air purification system of this invention includes a mattress having a foot, a head, and a width; an air filtration device; a filtered air distribution subsystem disposed at the head of the mattress including an enclosed air chamber with a number of openings therein facing the mattress and distributed across at least a substantial portion of the width of the mattress; and a duct interconnecting the air filtration device and the air chamber of the filtered air distribution subsystem to thereby provide a blanket of filtered air over the face of a person lying on the mattress. In one embodiment the filtered air distribution subsystem is configured as a headboard for the mattress. In another embodiment, the filtered air distribution subsystem is attached to an existing headboard.

The bed air purification system of this invention features an air filtration device; a filtered air distribution subsystem configured to be disposed at the head of a mattress and including an enclosed air chamber with a number of openings therein facing the mattress and distributed across at least a substantial portion of the width of the mattress; and a duct interconnecting the air filtration device and the air chamber of the filtered air distribution subsystem to thereby provide a blanket of filtered air over the face of a person lying on the mattress.

### BRIEF DESCRIPTION OF THE DRAWINGS

Other objects, features and advantages will occur to those skilled in the art from the following description of a preferred embodiment and the accompanying drawings, in which:

FIG. 1 is schematic view showing a prior art air filtration device located in the bedroom of an asthma or allergy sufferer;

FIG. 2 is a schematic view showing the primary components associated with the bed air purification system of the subject invention;

FIG. 3 is a side view of the purification system shown in FIG. 2;

FIG. 4 is a view similar to FIG. 3 except now the air filtration device is located at the foot of the bed;

FIGS. 5-7 are photographs showing different components of the prototype bed air purification system of the subject invention;

FIG. 8 is a side cut-away view showing the uniquely designed headboard of the subject invention;

FIG. 9 is a front view of the uniquely designed headboard in accordance with the subject invention;

FIG. 10 is schematic view showing the primary components associated with a typical air filtration device used in the air purification system of the subject invention; and

FIG. 11 is a schematic view showing a filtered air distribution subsystem attached to an existing headboard in accordance with another embodiment of the subject invention.

### DISCLOSURE OF THE PREFERRED EMBODIMENT

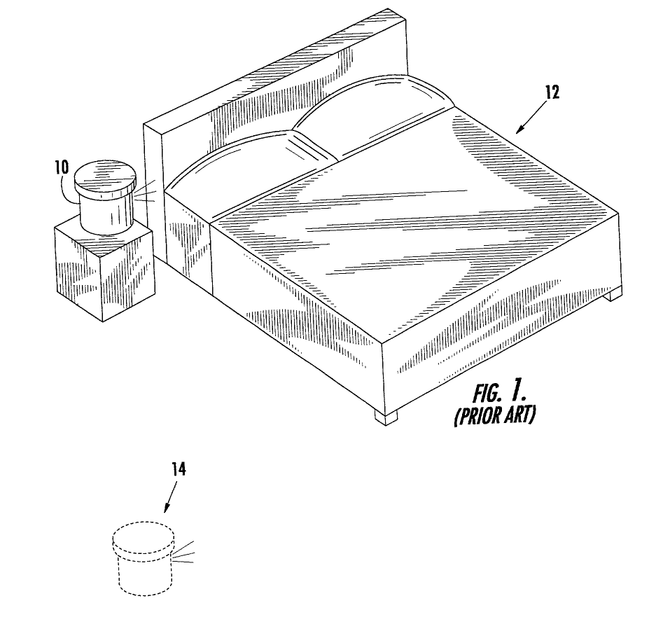

As discussed in the background section above, air filtration device 10, FIG. 1 adequately filters the air in the bedroom but the filtered air quickly mixes with non-filtered air even if air filtration device 10 is placed close to bed 12. As such, dander from a cat lying at the foot of the bed 12, pollutants in the air, and/or pollen entering from open windows are still breathed in by a person sleeping in bed 12 causing severe discomfort. Typically, air filtration device 10 is too noisy to be located as close to bed 12 as shown in FIG. 1. Moreover, the high air output rate of device 10 annoys the person or people sleeping on bed 12. Accordingly, air filtration device 10 is typically located some distance from bed 12 as shown at 14 where even more unfiltered air mixes with the filtered air output from air filtration device 10 and breathed in by a person sleeping on bed 12.

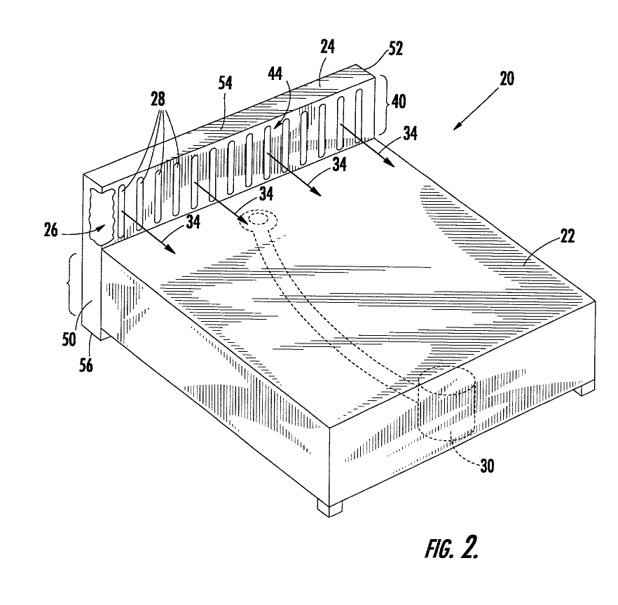

These shortcomings associated with the prior art are overcome in bed air purification system 20, FIGS. 2-4. System 20 includes mattress 22, headboard 24 at the head of mattress 22 with air chamber 26 therein and also including a number of openings 28 in communication with air chamber 26.

Air filtration device 30 may be located under mattress 22, beside it, or at the foot of the mattress 22 as shown in FIG. 4. Flexible four inch diameter (approximately) duct 32 interconnects air filtration device 30 and air chamber 26 of headboard 24 to thereby provide a blanket of filtered air directly over the face of a person lying on the mattress as shown by arrows 34.

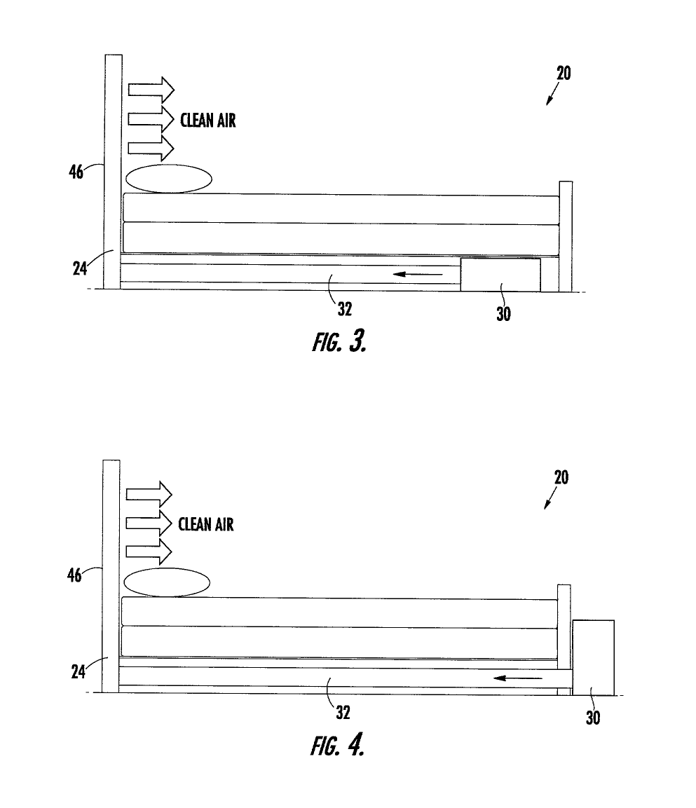

As shown in FIG. 2, the openings 28 in headboard 24 are typically vertically running slits. Other options include perforations and even ornate opening designs. Headboard 24 typically has upper portion 40 above the mattress and lower portion 42 below the mattress. Openings 28 are then disposed in the upper portion 40 of the headboard. In one example, headboard 24 includes front panel 44, FIG. 2; back panel 46, FIGS. 3-4; two sidewalls 50, 52; and a top 54 and bottom 56 defining therebetween vertical air chamber 26 which, in one example, was 45 inches high, 80 inches wide, and 3½ inches deep.

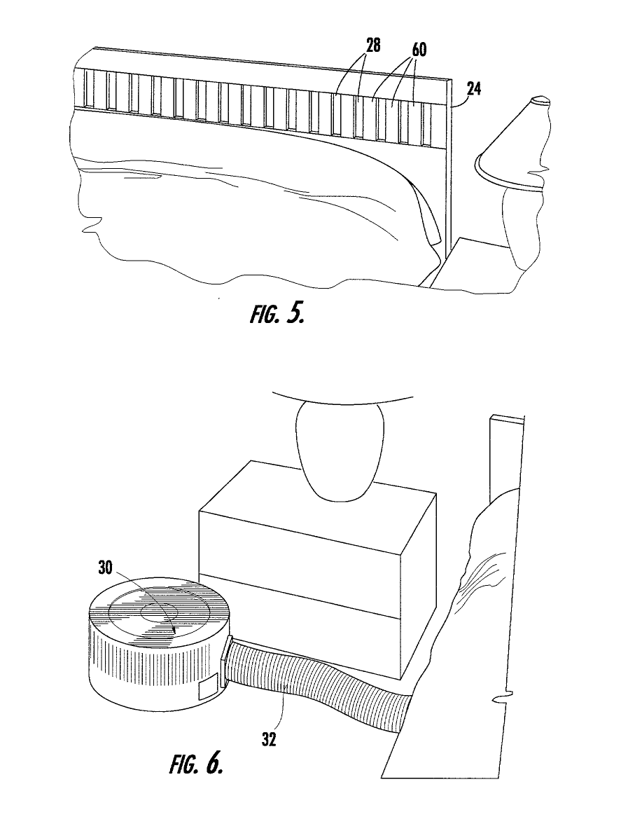

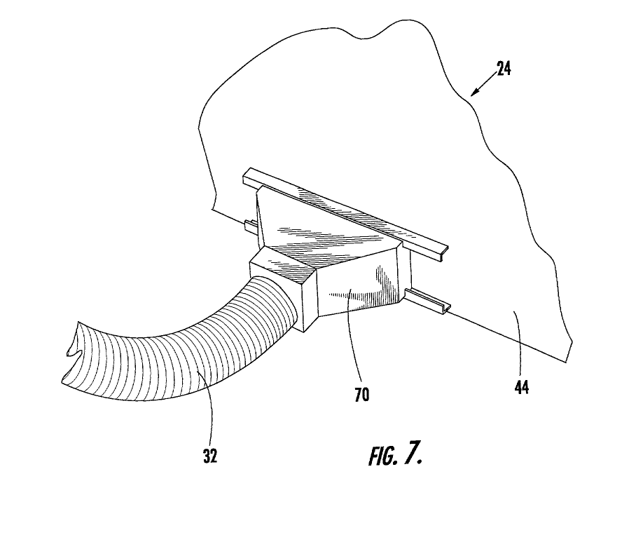

Front panel 44 includes upper portion 40 above mattress 22 and lower portion 42 below mattress 22. Upper portion 40 of front panel 44, in the prototype example shown in FIGS. 5-7, was made of spaced vertically running 2¼ inch wide oak slats 60 and openings 28 were the ⅛ inch spaces between the spaced oak slats 60.

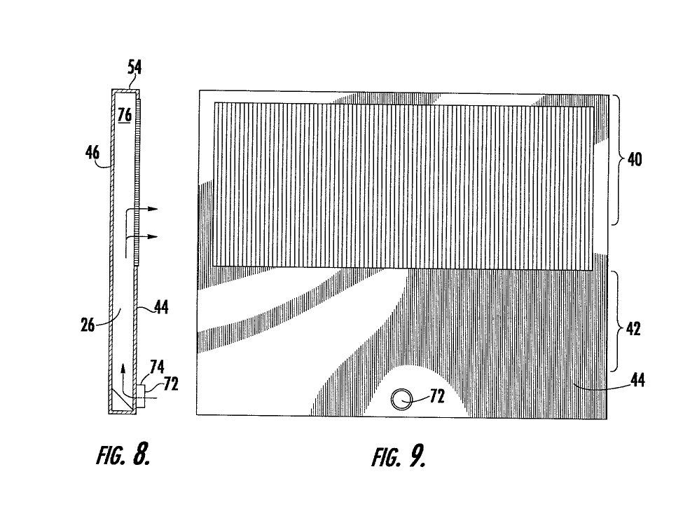

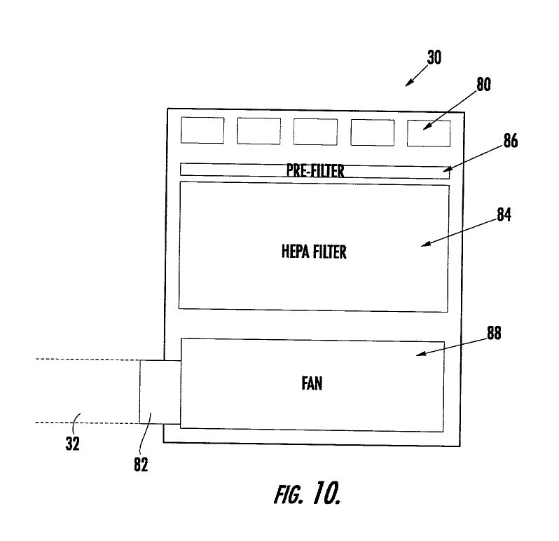

As shown in FIG. 7, manifold 70 interconnects flexible duct 32 to the center bottom portion of the front panel 44 of headboard 24. Thus, the center bottom portion of front panel 44 includes orifice 72 FIGS. 8-9 surrounded by collar 74, FIG. 8. Also, screen or grill 76, FIG. 8 may be located behind the slats to prevent debris from entering air chamber 26 and also to assist in creating a near laminar flow over the person lying in the bed.

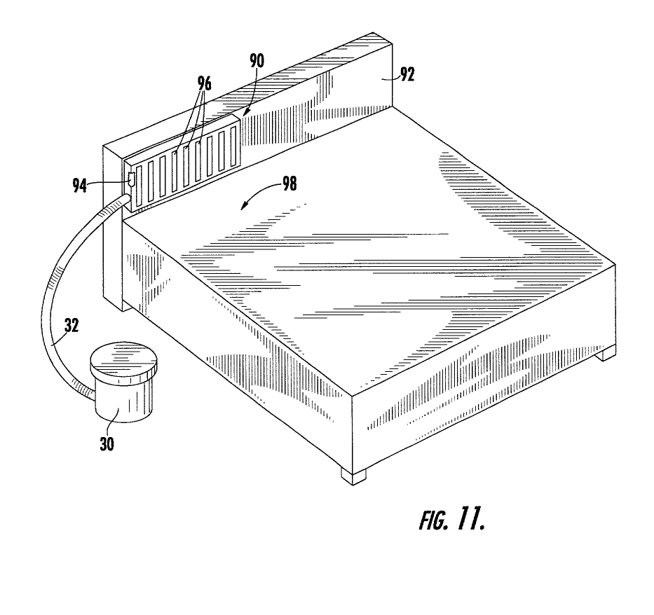

A typical air filtration device 30, FIG. 10 includes air intake 80, air outtake 82 connected to duct 32, a HEPA filter 84, a pre-filter 86, and centrifugal fan 88 which draws air in through air intake 80, through the two filters, and out outtake 82 into duct 32. Optional filtration devices include those with cooling, dehumidifying, humidifying, and even heating subsystems.

Thus far, the near laminar air flow openings have been shown to be distributed across the entire width of the headboard and the headboard itself includes the vertical air chamber. These are not necessary limitations of the subject invention, however.

As shown in FIG. 11, filtered air distribution subsystem 90 is disposed at the head of the mattress affixed to existing headboard 92 and includes an enclosed air chamber 94 with a number of openings 96 therein facing the mattress as shown and distributed across only a portion of the width of the mattress (here only half the mattress) to provide relief to a person sleeping on the left hand side of mattress 98. Still, as shown in FIG. 11, the openings are distributed across at least a substantial portion of the mattress. Duct 32 interconnects air filtration device 30 and air chamber 94 at the side of subsystem 90 to thereby provide a blanket of filtered air over the face of person lying on side 98 of the mattress. Other than its size and the ability to retrofit existing headboards with subsystem 90, however, subsystem 90 is otherwise typically configured similarly to the design shown in FIGS. 8 and 9.

In any embodiment, all size beds and even cribs located in homes, and beds in hospitals and nursing homes can employ either the system shown in FIGS. 2-10 or FIG. 11 to thereby provide a blanket of filtered air over the face of a person lying on a mattress. Non-filtered air is prevented from being mixed with filtered air by uniquely designed headboard 24, FIG. 5 or retrofit subsystem 90, FIG. 11 due to the openings distributed across the width thereof and the air filtration device connected to the headboard or retrofit system by a duct to thereby provide a low velocity blanket of only filtered air directly over the face of a person or persons lying on the bed.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A bed air purification system comprising:
a mattress;
a headboard at the head of the mattress with an air chamber therein and including a number of openings in communication with the air chamber;
an air filtration device; and
a duct interconnecting the air filtration device and the air chamber of the headboard to thereby provide a blanket of filtered air over the face of a person lying on the mattress.

2. The bed air purification system of claim 1 in which the openings are vertically running slits.

3. The bed air purification system of claim 1 in which the headboard has an upper portion above the mattress and a lower portion below the mattress, the openings disposed in the upper portion of the headboard.

4. The bed air purification system of claim I in which the headboard includes front and back panels, two sidewalls, and a top and a bottom defining the air chamber therebetween.

5. The bed air purification system of claim 4 in which the front panel includes an upper portion above the mattress and a lower portion below the mattress, the upper portion of the front panel made of spaced vertically running slats, the openings being the spacing between the spaced slats.

6. The bed air purification system of claim 5 further including a screen behind the slats.

7. The bed air purification system of claim 1 in which the air filtration device includes an air intake, an air outtake connected to the duct, a HEPA filter and a fan which draws air in through the air intake, through the HEPA filter, and out the outtake.

8. The bed air purification system of claim 1 in which the air filtration device is located under the mattress.

9. The bed air purification system of claim 1 in which the air filtration device is located at the foot of the mattress.

10. The bed air purification system of claim 1 in which the air filtration device is located beside the mattress.

11. The bed air purification system of claim 1 in which the openings are evenly distributed across the width of the headboard.

12. A bed air purification system comprising:
a mattress having a foot, a head, and a width;
an air filtration device;
a filtered air distribution subsystem disposed at the head of the mattress including an enclosed air chamber with a number of openings therein facing the mattress and distributed across at least a substantial portion of the width of the mattress; and
a duct interconnecting the air filtration device and the air chamber of the filtered air distribution subsystem to thereby provide a blanket of filtered air over the face of a person lying on the mattress.

13. The bed air purification system of claim 12 in which the openings are vertically running slits.

14. The bed air purification system of claim 12 in which the filtered air distribution subsystem is configured as a headboard for the mattress.

15. The bed air purification system of claim 14 in which the headboard has an upper portion above the mattress and a lower portion below the mattress, the openings disposed in the upper portion of the headboard.

16. The bed air purification system of claim 14 in which the headboard includes front and back panels, two sidewalls, and a top and bottom defining the air chamber therebetween.

17. The bed air purification system of claim 16 in which the front panel includes an upper portion above the mattress and a lower portion below the mattress, the upper portion of the front panel made of spaced vertically running slats, the openings being the spacing between the spaced slats.

18. The bed air purification system of claim 12 in which the openings are distributed evenly across the entire width of the mattress.

19. A bed air purification system comprising:
an air filtration device;
a filtered air distribution subsystem configured to be disposed at the head of a mattress and including an enclosed air chamber with a number of openings therein facing the mattress and distributed across at least a substantial portion of the width of the mattress; and
a duct interconnecting the air filtration device and the air chamber of the filtered air distribution subsystem to thereby provide a blanket of filtered air over the face of a person lying on the mattress.

20. The bed air purification system of claim 19 in which the openings are vertically running slits.

21. The bed air purification system of claim 19 in which the filtered air distribution is configured as a headboard for the mattress.

22. The bed air purification system of claim 21 in which the headboard has an upper portion above the mattress and a lower portion below the mattress, the openings disposed in the upper portion of the headboard.

23. The bed air purification system of claim 21 in which the headboard includes front and back panels, two sidewalls, and a top and bottom defining the air chamber therebetween.

24. The bed air purification system of claim 23 in which the front panel includes an upper portion above the mattress and a lower portion below the mattress, the upper portion of the front panel made of spaced vertically running slats, the openings being the spacing between the spaced slats.

25. The bed air purification system of claim 19 in which the openings are distributed evenly across the entire width of the headboard.
